(19) United States
(12) Patent Application Publication
(10) Pub. No.: US 2013/0099039 A1
(43) Pub. Date: Apr. 25, 2013

(54) CUTTING TOOTH WITH DUAL CUTTING EDGES FOR A BRUSH CUTTING HEAD

(71) Applicant: Daniel GAUDREAULT, Summerville, SC (US)

(72) Inventor: Daniel GAUDREAULT, Summerville, SC (US)

(73) Assignee: Gyro-Trac Corporation, Summerville, SC (US)

(21) Appl. No.: 13/278,608

(22) Filed: Oct. 21, 2011

(51) Int. Cl. B27L 11/00; B02C 18/18

(52) U.S. Cl. 241/282.2; 241/291; 241/285.1

(57) ABSTRACT

The present invention relates to a cutting tooth for attachment to a mounting block. The cutting tooth includes a longitudinal body provided with leading and trailing faces, and opposed, first and second cutting portions. The leading face has a projection disposed thereon to reinforce the longitudinal body. The trailing face has defined therein at least one threaded, blind bore. The at least one blind bore extends substantially into the projection but stops short of a leading projection face. It is configured to receive therein a threaded bolt for securing the cutting tooth to the mounting block. The first cutting portion terminates in a first cutting edge having an angle of attack of between 20 and 75 degrees. The second cutting portion terminates in a second cutting edge having an angle of attack between 20 and 75 degrees.

### FIELD OF THE INVENTION

The present invention relates generally to brush cutting heads, and more specifically, to a cutting tooth with dual cutting edges for a brush cutting head.

### BACKGROUND OF THE INVENTION

Extensive felling and mulching operations are often performed with a heavy-duty brush cutter mounted to the front of a work vehicle. A typical brush cutter includes a brush cutting head provided with an elongate support body that carries about its outer surface a plurality of teeth adapted to cut trees, brush or the like. The cutting teeth are typically fixed to the outer surface of the drum via mounting blocks.

An example of one such brush cutting head is described in United States Patent Publication No. 2010/0044487. This published patent application discloses a brush cutter that has a cylindrical support base and a plurality of mounting blocks fastened to the outer surface of the base. The bottom surface of each mounting block is concavely curved to match the radius of the base thereby allowing each mounting block to be welded onto the base with its bottom surface flush with the outer surface of the base. Each mounting block has a front face which is recessed from the front end of the mounting block so as to define a horizontal shelf near the bottom surface of the mounting block. Each mounting block carries a cutting tooth on its front or leading face. The cutting tooth is fastened to the mounting block by a nut and bolt combination, the bolt being inserted through a smooth bore defined in the mounting block.

To protect the mounting blocks from rocks and large trees, each mounting block is provided with a protective collar. Each protective collar is welded to the outer surface of the base and extends radially therefrom, transverse to the longitudinal axis of the base. Each collar terminates circumferentially a short distance from the front face of the mounting block with which it is associated to provide a front clearance space. The opposed end of the collar is welded to the back face of the associated mounting block to strengthen it.

The cutting tooth shown in this published patent application is formed with a relatively long, base portion at one end of which is carried a relatively short cutting portion. The cutting portion is angled forwardly and its front and rear (or leading and trailing) faces taper terminating in a cutting edge. A smooth-walled bore extending through the base portion is sized to accommodate therethrough a bolt which is inserted through the aligned bores in the cutting tooth base portion and the mounting block. The bolt secures the cutting tooth to the mounting block with a nut. At the end opposite the cutting portion, the base portion is provided with a projecting guide member sized to fit within fitting welded on the horizontal shelf of the mounting block. The guide member and fitting cooperate with each other to ensure that the cutting tooth maintains its proper orientation relative to the cutting block during operation of the brush cutting head. Additionally, the combination of guide member and fitting assists in distributing the impact forces applied to the cutting tooth through to the mounting block, thereby reducing the shear stress on the bolt.

In the field, the brush cutting head shown in United States Patent Publication No. 2010/0044487 has proven itself to be effective and well-suited to the task of brush cutting and land clearing. However, the design of the cutting tooth for this brush cutting head tends to suffer from certain disadvantages. Manufacture of the guide members projecting from the base portions of the cutting tooth must be precise and can be time consuming. Moreover, certain problems have been encountered when replacing old, broken or worn cutting teeth on the brush cutting head. In some cases, it has been found that the guide members projecting from the base portions of replacement cutting teeth do not always line up with the fittings on the mounting block into which they are to be received. As a result of this misalignment, some cutting teeth could not be properly secured to the mounting blocks, thereby causing delay, excessive warranty claims and requiring operators to carry on hand a greater number of replacement cutting teeth than would ordinarily be required.

Based on the foregoing, it would be desirable to have a cutting tooth which does not require a guide member to maintain its proper orientation on the mounting block, thereby obviating the drawbacks associated with the cutting tooth shown in United States Patent Publication No. 2010/0044487. Such a cutting tooth would be robust and capable of being securely fastened to the mounting block. It would be of further benefit if such a cutting tooth could possess an extended service life as compared to existing cutting teeth, so as to reduce the maintenance, repair and replacement of cutting teeth on a brush cutting head.

### SUMMARY OF THE INVENTION

In accordance with one broad aspect of the present invention, there is provided a cutting tooth for attachment to a mounting block carried on a brush cutting head. The cutting tooth includes a longitudinal body provided with a leading face; a trailing face; and a pair of opposed, first and second cutting portions carried at either end of the longitudinal body. The leading face has a projection disposed thereon to reinforce the longitudinal body. The projection has a leading projection face. The trailing face has defined therein at a location intermediate the ends of the longitudinal body at least one threaded, blind bore. The at least one blind bore extending substantially into the projection but stopping short of the leading projection face. The at least one blind bore is configured to receive therein a threaded bolt for securing the cutting tooth to the mounting block. The first cutting portion has a tapering profile that terminates in a first cutting edge. The first cutting edge has a first angle of attack relative to a first plane parallel to the midplane M. The first angle of attack lies between 20 degrees and 75 degrees. The second cutting portion has a tapering profile that terminates in a second cutting edge. The second cutting edge has a second angle of attack relative to a second plane parallel to the midplane M. The second angle of attack lies between 20 degrees and 75 degrees. When the cutting tooth is secured to the mounting block one of the first and second cutting portions is in an operative position and the other of the first and second cutting portions is in an inoperative position.

In one feature, the longitudinal body further includes a midplane M oriented transverse of the longitudinal body. The longitudinal body is symmetrical about the midplane M such that the first cutting portion is a mirror image of the second cutting portion. In another feature, the longitudinal body further includes a plane P perpendicular to the midplane M. The longitudinal body is symmetrical about the plane P. In a further feature, the longitudinal body has an hourglass shape.

In an additional feature, the longitudinal body further includes a base portion having a leading face and an opposed trailing face. The base portion is disposed between the first and second cutting portions. In one feature, the base portion is sized longer than at least one of the cutting portions. In another feature, the base portion is sized longer than both the cutting portions. The base portion has a length L₁ and the first cutting portion has a length L₂. The ratio L₂:L₁ lies between approximately 0.17 and approximately 0.44. The second cutting portion has a length L₃. The ratio L₃:L₁ lies between approximately 0.17 and approximately 0.44.

In yet another feature, the base portion has a pair of opposed lateral faces. The width of the base portion as measured between the lateral faces tapers toward the midplane.

In still another feature, the projection occupies a substantial portion of the base portion leading face. Moreover, the projection has a substantially rectangular shape defined by smoothly-radiused sides. In one feature, the leading projection face is planar and is generally parallel to the base portion trailing face.

In a further feature, the at least one blind bore includes a first blind bore located adjacent the juncture of the base portion and the first cutting portion, and a second blind bore located adjacent the juncture of the base portion and the second cutting portion.

In an additional feature, the cutting tooth further includes means for preventing rotation of the cutting tooth relative to the mounting block. The rotation preventing means includes a pair of spaced apart, raised abutment members projecting from the trailing face of the base portion and extending longitudinally therealong. The spacing between the abutment members being sized large enough to accommodate a portion of the mounting block therein.

In a different feature, the first angle of attack is equal to the second angle of attack and measures 49 degrees. In an alternative feature, the first angle of attack is greater than the second angle of attack.

In yet another feature, the first and second cutting edges define a cutting tooth envelope capable of accommodating a circle having a diameter ranging between 3.5 and 4.9 in. When the first and second angles of attack measure 20 degrees, the cutting tooth envelope is capable of accommodating a circle having a diameter measuring 3.5 in. When the first and second angles of attack measure 49 degrees, the cutting tooth envelope is capable of accommodating a circle having a diameter measuring 4.4 in. When the first and second angles of attack measure 75 degrees, the cutting tooth envelope is capable of accommodating a circle having a diameter measuring 4.9 in.

In accordance with another broad aspect of the present invention, there is provided a cutting tooth assembly for a brush cutting head. The cutting tooth assembly includes a mounting block carried on the brush cutting head. The mounting block has a leading face, a trailing face and a bore extending between the leading and trailing faces of the mounting block. Also provided is a cutting tooth releasably attachable to the mounting block. The cutting tooth having a longitudinal body provided with a leading face; a trailing face; and a pair of opposed, first and second cutting portions carried at either end of the longitudinal body. The leading face has a projection disposed thereon to reinforce the longitudinal body. The projection has a leading projection face. The trailing face has defined therein at a location intermediate the ends of the longitudinal body at least one threaded, blind bore. The at least one blind bore extending substantially into the projection but stopping short of the leading projection face. The at least one blind bore is configured to receive therein a threaded bolt for securing the cutting tooth to the mounting block. The first cutting portion has a tapering profile that terminates in a first cutting edge. The first cutting edge has a first angle of attack relative to a first plane parallel to the midplane M. The first angle of attack lies between 20 degrees and 75 degrees. The second cutting portion has a tapering profile that terminates in a second cutting edge. The second cutting edge has a second angle of attack relative to a second plane parallel to the midplane M. The second angle of attack lies between 20 degrees and 75 degrees. The cutting tooth assembly further includes a bolt for fastening the cutting tooth to the mounting block. The bolt is insertable into the at least one blind bore of the longitudinal body and the bore defined in the mounting block. When the cutting tooth is secured to the mounting block one of the first and second cutting portions is in an operative position and the other of the first and second cutting portions is in an inoperative position.

In another feature, the at least one blind bore includes a first blind bore located nearer to the first cutting portion than to the second cutting portion, and a second blind bore located nearer to the second cutting portion than to the first cutting portion. When the cutting tooth is secured to the mounting block with the first cutting portion in the operative position, the bolt extends through the second blind bore. When the cutting tooth is secured to the mounting block with the second cutting portion in the operative position, the bolt extends through the first blind bore.

In accordance with yet another broad aspect of the present invention, there is provided a brush cutting head. The brush cutting head includes a plurality of mounting blocks carried on the brush cutting head. Each mounting block of the plurality has a leading face, a trailing face and a bore extending between the leading and trailing faces of the mounting block. Also provided is a plurality of cutting teeth releasably attachable to the plurality of mounting blocks. Each cutting tooth has a longitudinal body provided with a leading face; a trailing face; and a pair of opposed, first and second cutting portions carried at either end of the longitudinal body. The leading face has a projection disposed thereon to reinforce the longitudinal body. The projection has a leading projection face. The trailing face has defined therein at a location intermediate the ends of the longitudinal body at least one threaded, blind bore. The at least one blind bore extending substantially into the projection but stopping short of the leading projection face. The at least one blind bore is configured to receive therein a threaded bolt for securing the cutting tooth to the mounting block. The first cutting portion has a tapering profile that terminates in a first cutting edge. The first cutting edge has a first angle of attack relative to a first plane parallel to the midplane M. The first angle of attack lies between 20 degrees and 75 degrees. The second cutting portion has a tapering profile that terminates in a second cutting edge. The second cutting edge has a second angle of attack relative to a second plane parallel to the midplane M. The second angle of attack lies between 20 degrees and 75 degrees. The brush cutting head further includes a plurality of bolts for fastening the plurality of cutting teeth to the plurality of mounting blocks. Each bolt of the plurality is insertable into the at least one blind bore of one of the cutting teeth of the plurality and the bore defined in the corresponding one of the mounting blocks of the plurality.

In accordance with still another broad aspect of the present invention, there is provided a cutting tooth for attachment to a mounting block carried on a brush cutting head. The cutting tooth includes a longitudinal body provided with a leading face; a trailing face; a midplane M oriented transverse of the longitudinal body; a pair of opposed, first and second cutting portions carried at either end of the longitudinal body and extending away from each other and away from the leading face in a forwardly leaning fashion; and at least one threaded blind bore defined in the trailing face at a location intermediate the first and second cutting portions. The at least one threaded blind bore is configured to receive therein a threaded bolt for securing the cutting tooth to the mounting block. The first cutting portion has a tapering profile that terminates in a first cutting edge. The first cutting edge has a first angle of attack relative to a first plane parallel to the midplane M. The first angle of attack lies between 20 degrees and 75 degrees. The second cutting portion has a tapering profile that terminates in a second cutting edge. The second cutting edge has a second angle of attack relative to a second plane parallel to the midplane M. The second angle of attack lies between 20 degrees and 75 degrees. The first and second cutting edges define a cutting tooth envelope capable of accommodating a circle having a diameter ranging between 3.5 and 4.9 in. When the cutting tooth is secured to the mounting block one of the first and second cutting portions is in an operative position and the other of the first and second cutting portions is in an inoperative position. When the first and second angles of attack measure 20 degrees, the cutting tooth envelope is capable of accommodating a circle having a diameter measuring 3.5 in. When the first and second angles of attack measure 49 degrees, the cutting tooth envelope is capable of accommodating a circle having a diameter measuring 4.4 in. When the first and second angles of attack measure 75 degrees, the cutting tooth envelope is capable of accommodating a circle having a diameter measuring 4.9 in.

### BRIEF DESCRIPTION OF THE DRAWINGS

The embodiments of the present invention shall be more clearly understood with reference to the following detailed description of the embodiments of the invention taken in conjunction with the accompanying drawings, in which:

FIG. 1 is a front perspective view of a brush cutter provided with a housing and a brush cutting head, all according to an embodiment of the present invention;

FIG. 2 is a front perspective view of the brush cutting head of FIG. 1 shown in isolation;

FIG. 3 is an end view of the brush cutting head shown in FIG. 2;

FIG. 4A is an enlarged view similar to that illustrated in FIG. 3 depicting the encircled portion ‘4A’ except that it is taken in cross-section, the first cutting edge being shown occupying its operative position and the second cutting edge being shown occupying its non-operative position;

FIG. 4B is a view similar to that shown in FIG. 4A, except that the first cutting edge is shown occupying its non-operative position and the second cutting edge is shown occupying its operative position;

FIG. 5 is a front, partial perspective view of the brush cutting head of FIG. 2 showing a representative cutting tooth and its corresponding mounting assembly fixed to the tubular support body of the brush cutting head;

FIG. 6 is a rear, partial perspective view of the brush cutting head of FIG. 2 showing a representative cutting tooth and its corresponding mounting assembly fixed to the tubular support body of the brush cutting head;

FIG. 7 is a side elevation view of one of the collars shown in FIG. 2;

FIG. 8 is a front perspective view of the mounting block shown in FIG. 5;

FIG. 9 is a rear perspective view of the mounting block shown in FIG. 5;

FIG. 10 is a side elevation view of the mounting block shown in FIG. 5;

FIG. 11 is a front perspective view of the cutting tooth shown in FIG. 5;

FIG. 12 is a rear perspective view of the cutting tooth shown in FIG. 5;

FIG. 13 is a front end view of the cutting tooth shown in FIG. 5;

FIG. 14 is a rear end view of the cutting tooth shown in FIG. 5;

FIG. 15A is a side elevation view of the cutting tooth shown in FIG. 5;

FIG. 15B is another side elevation view of the cutting tooth similar to that shown in FIG. 15A; and

FIG. 16 is an end view of the brush cutting head similar to that illustrated in FIG. 3 except that the plurality of collars and mounting blocks are made transparent to better reveal different possible orientations of the cutting edges of the plurality of the cutting teeth.

### DETAILED DESCRIPTION OF THE EMBODIMENTS OF THE INVENTION

The description which follows, and the embodiments described therein are provided by way of illustration of an example, or examples of particular embodiments of principles and aspects of the present invention. These examples are provided for the purposes of explanation and not of limitation, of those principles of the invention. In the description that follows, like parts are marked throughout the specification and the drawings with the same respective reference numerals.

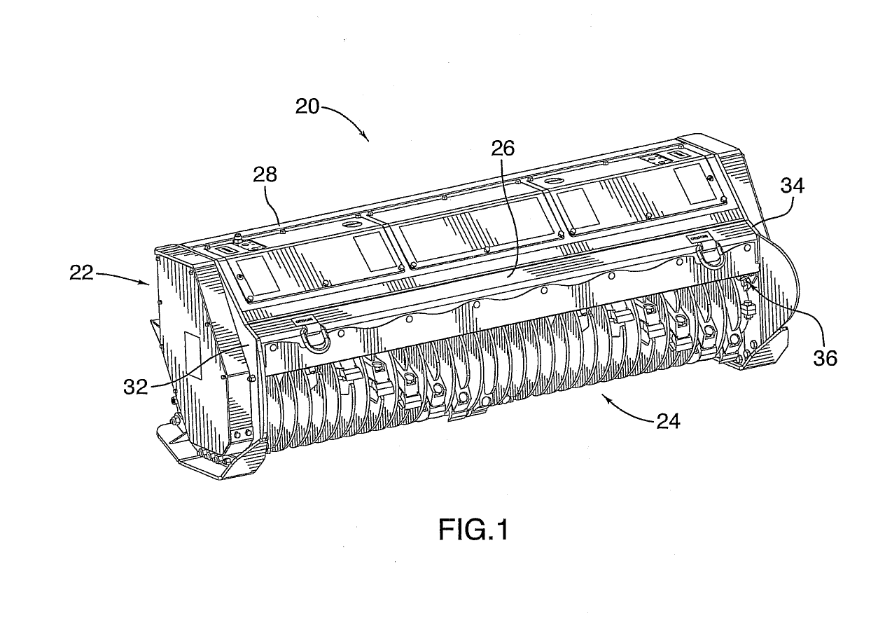

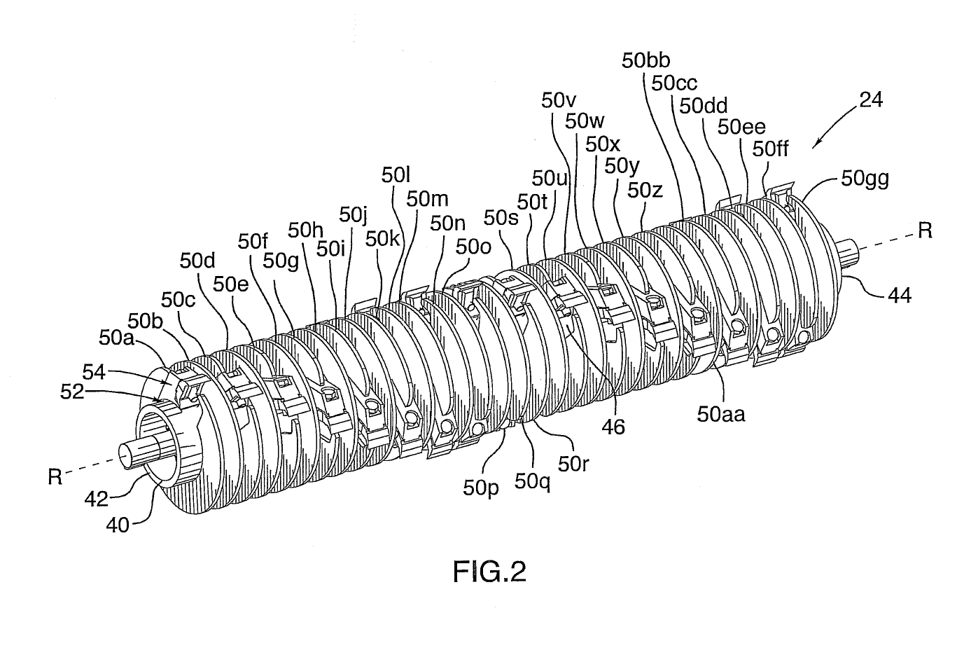

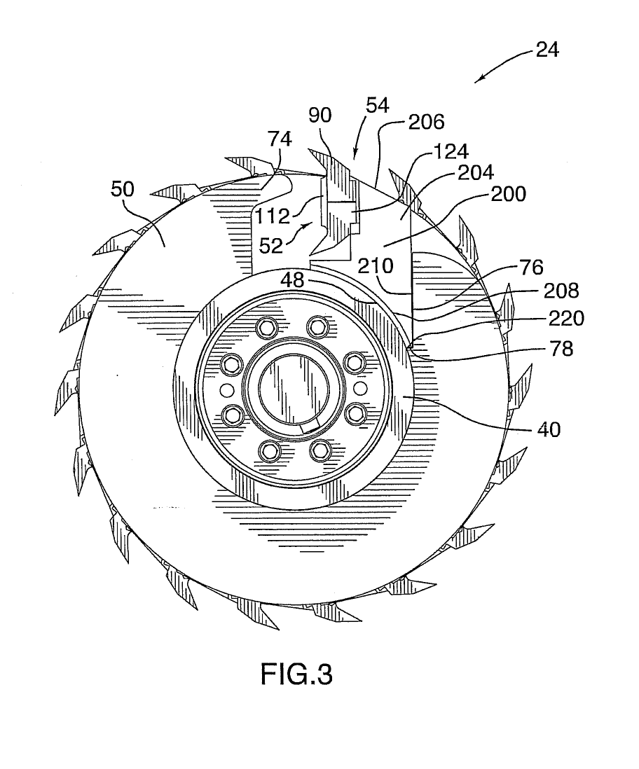

Referring to FIG. 1, there is shown a brush cutter generally designated with reference numeral 20. Brush cutter 20 may be of the type attached to the front of a vehicle, such as a loader, skid steer, or the like. Brush cutter 20 includes an open-bottom housing 22 and a brush cutting head 24 rotatably mounted within the housing 22. The housing 22 is defined generally by a front cover panel 26, a rear cover panel 28 and a pair of side panels 32 and 34. The cover panels 26 and 28 extend longitudinally between, and are joined to, the side panels 32 and 34. A curved wall (not shown) disposed within the interior of the housing 22 spans the space between the side panels 32 and 34, its curved profile partially defining a well 36 sized to accommodate the brush cutting head 24. The brush cutting head 24 is mounted longitudinally between the side panels 32 and 34 and supported on bearing assemblies (not shown) for rotational motion about an axis of rotation R-R (shown in FIG. 2). A drive assembly (not shown) is operatively connected to the brush cutting head 24 to drive rotation thereof.

Referring now to FIG. 2, there is shown the brush cutting head 24. The brush cutting head 24 includes a tubular support body 40 that has a first end 42, an opposed second end 44 and an intermediate portion 46 extending between the first and second ends 42 and 44. In this embodiment, the support body 40 is cylindrical and has an outer diameter of 9.94 in. This, however, need not be the case in every application. In alternative embodiments, the support body may be sized or shaped differently.

The intermediate portion 46 has a curved outer surface 48 that defines the circular cross-section of the support body 40. Concentrically mounted to the support body 40 at spaced intervals along the intermediate portion 46, is a plurality of protective collars designated with reference numerals 50a through to 50gg (collectively, “collars 50”). As will be explained in greater detail below, each collar 50 has associated therewith a mounting site or station 52 for receiving a cutting tooth assembly 54 therein.

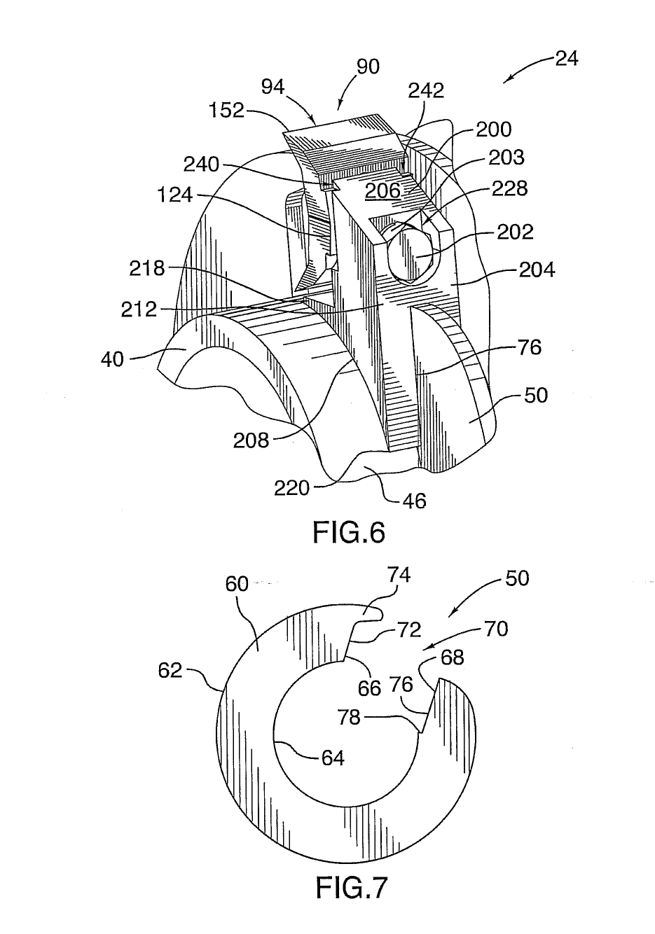

Referring to FIG. 7, each collar 50 is has a substantially penannular structure defined by a relatively flat, circumferentially extending, sidewall 60. The sidewall 60 is bounded circumferentially by an outer edge 62 and inner edge 64, and has first and second spaced apart ends 66 and 68. The space between the ends 66 and 68 defines a relatively large cutout 70 formed in the collar 50. In this embodiment, each station 52 is defined at least partially within the cutout 70 formed in a given collar 50.

The first end 66 of the sidewall 60 has a relatively straight edge 72 that spans between the outer and inner edges 62 and 64. Jutting out from the edge 72 adjacent the outer edge 62 is a relatively short, finger-like projection 74 which extends toward the second end 68. During operation of the brush cutting head 24, the projection 74 serves to block or prevent large pieces of wood from getting wedged or stuck in the space defined between the collar 50 and the cutting tooth assembly 54. The second end 68 of the sidewall 60 is also formed with a relatively straight edge 76 disposed opposite the edge 72 of the first end 66 in a substantially parallel arrangement. The orientation of the edges 72 and 74 is skewed relative to a notional radial line RL of the collar 50. Adjacent the inner edge 64, the edge 76 has defined therein a relatively small shoulder 78.

The collars 50 are radially mounted to the support body 40 with their inner sidewall edges 64 welded to the curved surface 48. Each collar 50 is longitudinally spaced and radially offset from its adjacent collar 50 such that the cutouts 70 of adjacent collars (and their associated stations) are staggered relative to each other. Preferably, adjacent stations 50 are staggered relative to each other by an angle of approximately 160 degrees. However, in alternative embodiments, adjacent stations could be staggered by a greater or lesser angle.

Due to this stagger and the geometry of the collars 50, every alternate station 52 is also radially offset from its respective reference station by an angle ω₁. Preferably, the angle ω₁ is an acute angle. In this embodiment, the angle ω₁ measures approximately 20 degrees.

In this embodiment, the staggered arrangement of the collars 50 allows the plurality of cutting tooth assemblies 54 to be disposed along the support body 40 in a generally double helix pattern thereby permitting cutting across the entire length of the support body 40 when the brush cutting head 24 is rotated about its longitudinal axis ‘R-R’. While a double helix pattern is generally preferred, it will be appreciated that the cutting tooth assemblies 54 could be laid out differently along the support body 40 to achieve a particular distribution or arrangement of cutting tooth assemblies 54 on the support body 40. For instance, the cutting tooth assemblies could be disposed in a triple or quadruple helix arrangement.

In this embodiment, the diameter of the support body 40 with collars 50 mounted thereto (as measured to the outer edge 62 of the collars 50) is 17.75 in. In other embodiments, this diameter may be different.

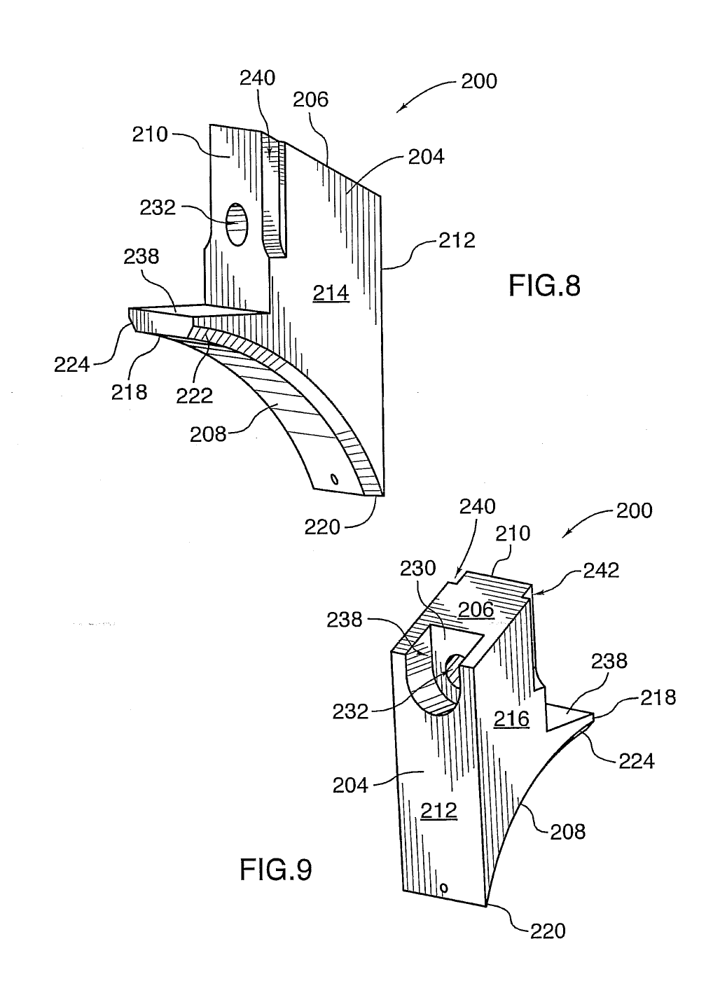

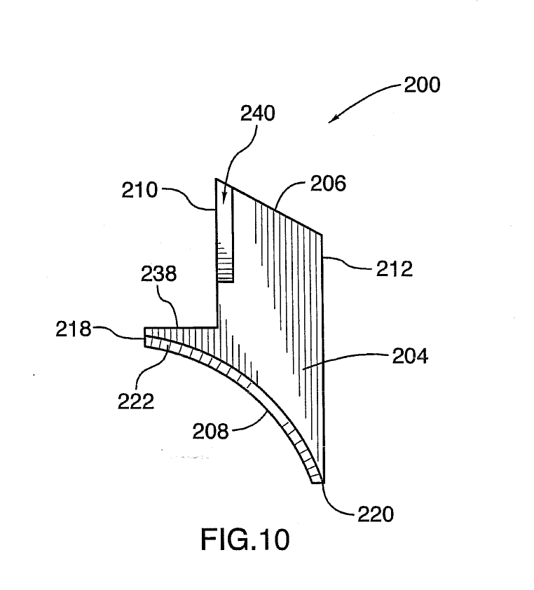

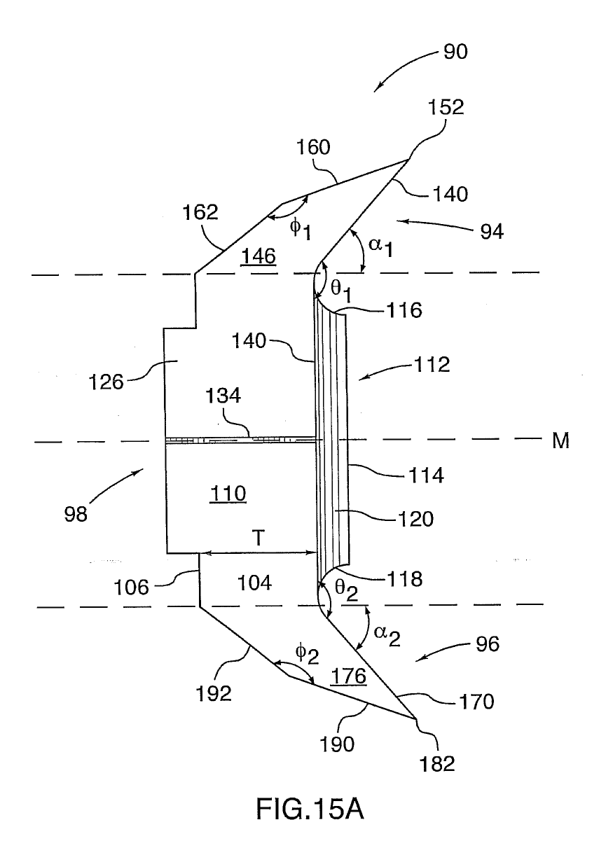

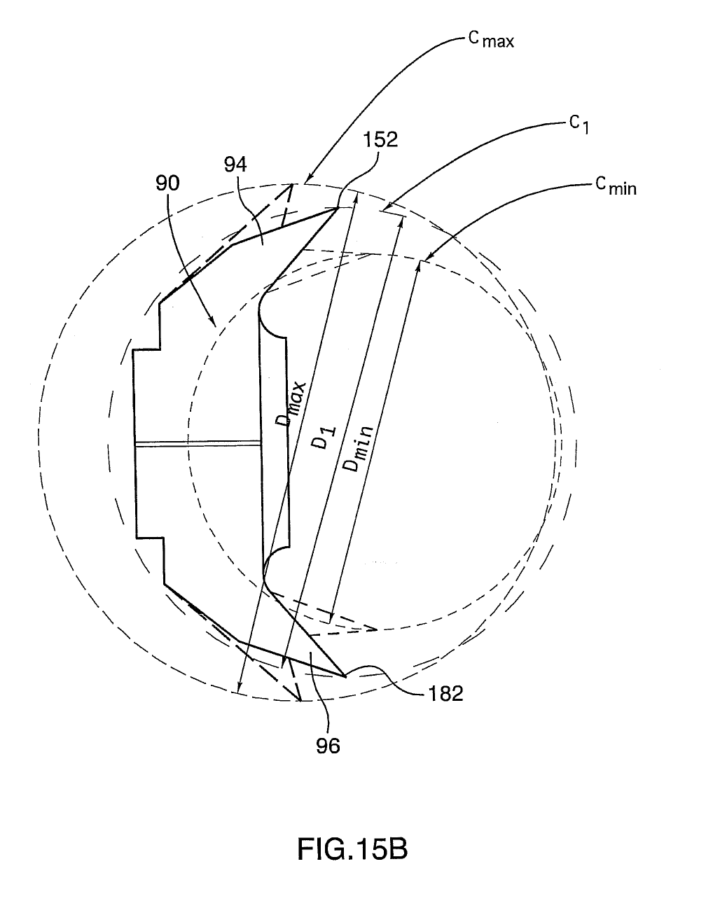

The cutting tooth assembly 54 is now described in greater detail with reference to FIGS. 8 to 15B. The cutting tooth assembly 54 includes a cutting tooth 90 and a mounting assembly 92 for securely fixing the cutting tooth 90 within a respective station 52. The cutting tooth 90 has a body provided with a first cutting portion 94, a second cutting portion 96 disposed opposite the first cutting portion 94 and a base portion 98 integrally formed with, and extending between, the first and second cutting portions 94 and 96. As best shown in FIGS. 14 and 15A, in this preferred embodiment, the cutting tooth 90 can be seen to be symmetrical about the midplane M of the base portion 98, such the first cutting portion 94 is a mirror image of the second cutting portion 96. Preferably, the cutting tooth 90 is also symmetrical about a plane P perpendicular to the midplane M.

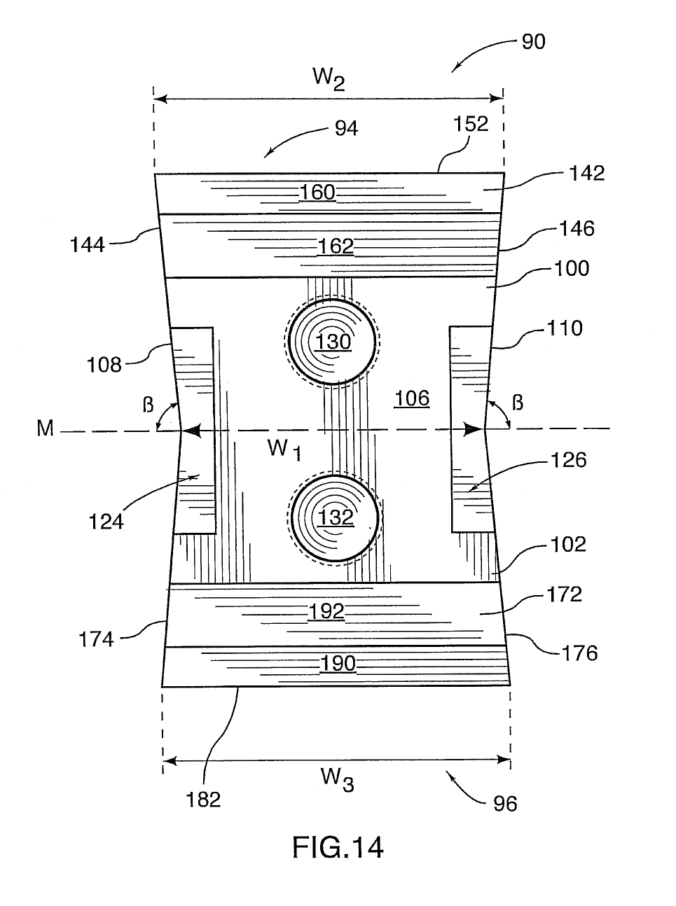

The base portion 98 has a first end 100, an opposed second end 102, a leading face 104, a trailing face 106 and two, spaced apart, lateral faces 108 and 110 which extend between the leading and trailing faces 104 and 106. A generally rectangular projection 112 is centrally disposed on the leading face 104. The projection 112 can be seen to be defined by a generally planar face 114 projecting further in the leading direction than the leading face 104, two opposed short sides 116 and 118, and two opposed long sides 120 and 122. As best shown in FIGS. 13 and 15A and 15B, the sides 116, 118, 120 and 122 are all smoothly radiused to enhance clearance of the cutting debris away from the cutting tooth 90, and more specifically, from the first and second cutting portions 94 and 96. Moreover, by having sides 116, 118, 120 and 122 smoothly radiused improved stress distribution may be achieved.

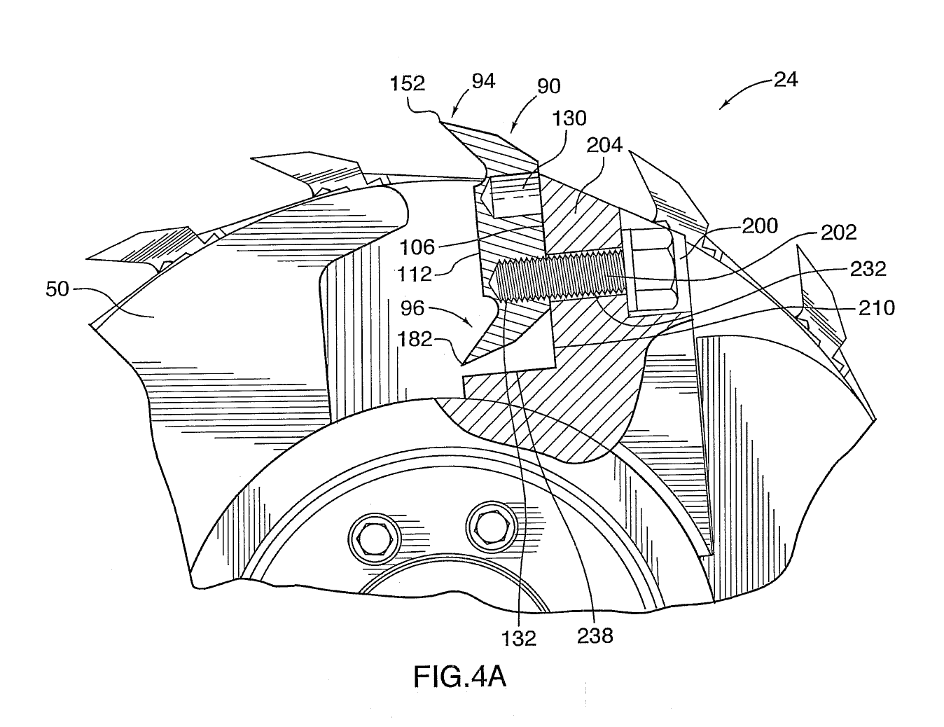

The projection 112 thickens the base portion 98 thereby permitting for the provision of sufficient threading 123 in blind bores 130 and 132 formed in the trailing face 106 of the base portion 98 so as to accommodate a longer bolt for fastening the cutting tooth 90 to mounting block 200 which forms part of the mounting assembly 92. As visible in FIGS. 4A and 4B, such threading 123 extends substantially into the base portion 98 just short of face 114 of the projection 112. Additionally, the projection 112 reinforces the base portion 98 and serves as an impact-absorbing function.

In this embodiment, the thickness T of the base portion 98 (as measured between the trailing face 106 and the planar face 114 of the projection 112) is 1.19 in. In other embodiments, the thickness T could be made larger.

Moreover, in this embodiment, the face 114 of the projection 112 is planar and is generally parallel with the trailing face 106 of the base portion 98. In other embodiments, the face 114 could have a different orientation and be skewed relative to the trailing face of the base portion.

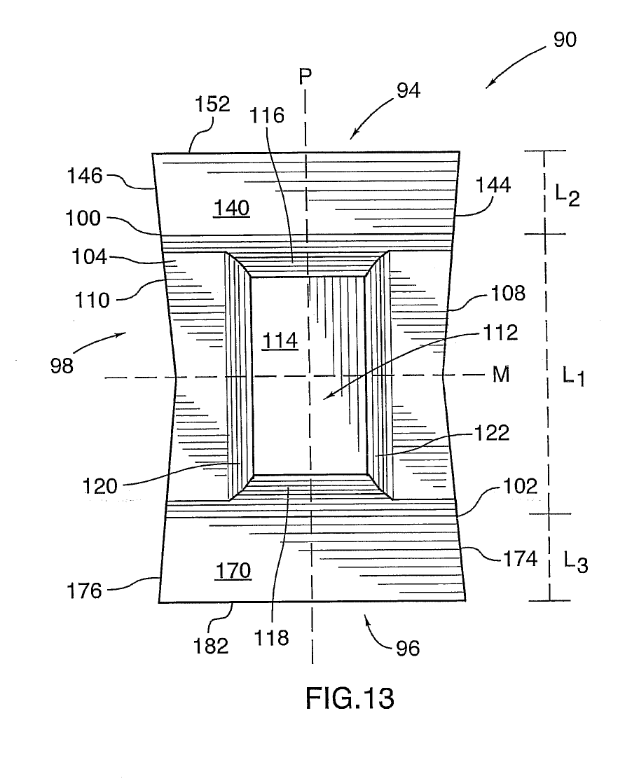

In FIGS. 12 and 14, there is shown a pair of spaced apart, raised abutment or shoulder members 124 and 126 projecting from the trailing face 106 of the base portion 98. More specifically, the abutment members 124 and 126 extend longitudinally along the outer margins of the trailing face 106 and are positioned centrally between, but at a short distance away from, the first and second ends 100 and 102 of the base portion 98. The outer edges of the abutment members 124 and 126 are disposed flush with the lateral faces 108 and 110 of the base portion 98. The spacing between the abutment members 124 and 126 is sized large enough to accommodate a portion of the mounting block therein. The abutment members 124 and 126 cooperate with each other to hold the cutting tooth 90 in place and discourage rotation of the cutting tooth 90 relative to the mounting assembly 92 thereby ensuring that the cutting tooth 90 maintains the proper orientation for optimal cutting effectiveness during operation of the brush cutting head 24.

The trailing face 106 of the base portion 98 is formed with a first threaded blind bore 130 proximate the first cutting portion 94 and a second threaded blind bore 132 proximate the second cutting portion 96. Each blind bore 130, 132 is formed with threading 123 which extends deeply into the base portion 98 stopping just shy of the plane defining the leading face 104. Beyond the threading 123, each blind bore 130, 132 tapers to a conical end 133. Each end 133 extends beyond the leading face 104 and into the projection 112, stopping only a short distance from the planar face 114 of the projection 112.

The first and second blind bores 130 and 132 are aligned with each other along a plane disposed perpendicular to the midplane M and are located roughly midway between the abutment members 124 and 126. Each blind bore 130, 132 is adapted to receive a fastener therethrough to permit the cutting tooth 90 to be fastened to a portion of the mounting assembly 92 in one of two orientations. As explained in greater detail below, when it is intended that the first cutting portion 94 engage or act upon brush material to be cut, the fastener (or bolt) will be inserted through the second blind bore 132 (see FIG. 4A). On the other hand, where the second cutting portion 96 is to engage or act upon brush material to be cut, then the fastener (or bolt) will be made to extend into the first blind bore 130 (see FIG. 4B).

In alternative embodiments, the base portion 98 can be configured to have a single blind bore which would serve to locate a bolt for attachment of the cutting tooth to a portion of the mounting assembly. In such an embodiment, the blind bore would be used regardless of whether it was the first or second cutting edge that was required to be put in its respective operative position. The length of the base portion would likely need to be reduced in order to put into effect this change of configuration.

As best shown in FIGS. 13 and 14, the base portion 98 is tapered at the midplane M thereby imparting an hourglass-like shape to the base portion 98 (and the cutting tooth 90). More specifically, starting from the juncture of the first cutting portion 94 and the base portion 98, the lateral faces 108 and 110 extend toward the midplane M in a converging fashion. Starting from the midplane M and moving toward the second cutting portion 96, the lateral faces 108 and 110 diverge. In this embodiment, the angle β formed between each of the lateral faces 108 and 110 and the midplane M is 85 degrees. Stated another way, there is 5 degree taper moving from the first end 100 or second end 102 of the base portion 98 to the midplane M. In other embodiments, the angle β may be modified (i.e. increased or decreased) to suit a particular design. In still other embodiments, the base portion could be configured so that its lateral faces are disposed parallel to each other.

In this embodiment, the narrowest width W₁ of the base portion 98 occurs at the midplane with the width W₁ measuring 2.62 in. The length L₁ of the base portion 98 as measured from the first end 100 to the second end 102 is 2.62 in. In other embodiments, the base portion could be proportioned differently (i.e. with a smaller or larger width and/or length).

At the midplane M, a groove 134 is defined in each lateral face 108, 110. In each case, the groove 134 extends from the leading face 104 beyond the trailing face 106 to ultimately terminate at the trailing edge of the abutment shoulder member 124, 126 (as the case may be). The purpose of the grooves 134 is to prevent the concentration of stresses along the midplane M.

While it is generally preferred that the cutting tooth be provided with a base portion, it will be appreciated that this need not be the case in every application. In alternative embodiments, the cutting tooth could be made without a discernible base portion, as a result of the cutting portions having been reconfigured (and resized) to subsume the base portion.

A description of the first and second cutting portions 94 and 96 now follows. The first cutting portion 94 is carried on the first end 100 of the base portion 98 in a generally, forwardly leaning or canted fashion. The first cutting portion 94 has a leading face 140, an opposed trailing face 142 and two spaced-apart lateral faces 144 and 146. The leading face 140 of the first cutting portion 94 joins the leading face 104 of the base portion 98 while the trailing face 142 joins the trailing face 106. As best shown in FIG. 15B, an external obtuse angle θ₁ is formed between the leading face 140 and the leading face 104. In this embodiment, the angle θ₁ measures approximately 139 degrees. In other embodiments, a different angle may be employed.

Each lateral face 144, 146 is coplanar with the corresponding lateral face 108, 110 of the base portion 98 such that the one merges smoothly with the other; the orientation of the lateral faces 144 and 146 contributing to the overall hourglass shape of the cutting tooth 90.

The leading and trailing faces 140 and 142 cooperate with each other to define a tapering, wedge-like, profile 150 that terminates in a first cutting edge 152. The first cutting edge 152 is carried forwardly of the leading face 104 of the base portion 98 such that when the first cutting portion 94 is in its operative orientation it tends to be the first element of the cutting tooth 90 to make contact with the brush to be cut. The first cutting edge 152 is carried at an angle α₁ (as measured between the leading face 140 and a notional plane extending parallel to the midplane M). The angle α₁ corresponds to the “angle of attack” of the first cutting portion 94, that is, the angle at which the first cutting edge 152 approaches the material to be cut. Preferably, this angle α₁ measures between about 20 degrees and about 75 degrees. In the embodiment shown in FIG. 15B, the angle α₁ measures 49 degrees. It will be appreciated that a smaller angle of attack may be desirable in instances where the brush to be cut includes harder woods. Conversely, a larger angle of attack may be used where the first cutting edge 152 is intended to act on softer woods.

The first cutting edge 152 extends generally linearly between the lateral faces 144 and 146 and substantially parallel to the rotational axis R-R of the brush cutting head 24. However, in alternative embodiments, the first cutting edge could be configured differently. For instance, the first cutting edge could be configured to extend generally diagonally between the lateral faces 144 and 146, askew of the rotational axis R-R. This configuration would tend to favor one end of the cutting edge over the other contacting the brush. In a further alternative, the first cutting edge could be scalloped or formed to extend in a generally, zigzagging fashion.

In this embodiment, the width W₂ of the first cutting edge 152 measures 3.0 in. In other embodiments, the width of the first cutting edge could be greater or lesser.

When the cutting tooth 90 is mounted within the station 52 and the first cutting portion 94 is in its operative orientation, the first cutting edge 152 extends beyond the outer sidewall edges 62 of adjacent collars 50 to facilitate the cutting action of the tooth. In operation, the first cutting edge 152 of each cutting tooth 90 comes into contact with the brush thereby creating debris as a result of the cutting action of the cutting tooth 90. As the debris passes over the first cutting edge 152, it abrades the surface of the first cutting edge 152 thereby sharpening the cutting tooth 90. This sharpening action tends to maintain or enhance the cutting efficiency of the cutting tooth and tends to reduce the need for mechanical sharpening. Thereafter the debris may travel along the leading and/or trailing face 140 and 142 to be carried away from first cutting edge 152. As shown in FIG. 4A, the first cutting portion 94 is spaced away from the finger-like projection 74 of the collar 50 so as to provide a clearance for the passage of debris. Beyond the finger-like projection 74, a larger clearance for evacuating debris exists between the edge 72 of the collar 50, and the base portion 98 and the second cutting portion 96.

Returning to FIGS. 12 and 15A and 15B, the trailing face 142 of the first cutting portion 94 has an upper portion 160 and a lower portion 162. The upper portion 160 extends between the first cutting edge 152 and the lower portion 162. The upper portion 160 is bent relative to the lower portion 162 such that an internal obtuse angle φ₁ is defined therebetween. In the present embodiment, the angle φ₁ measures approximately 161 degrees. In other embodiments, a different angle may be employed.

In the embodiment shown in FIG. 12, the upper and lower portions 160 and 162 of the trailing face 142 are shown to be planar. This need not be the case in every application. In other embodiments, it may be possible to define within these portions an arrangement of alternating grooves and ridges extending generally transverse of the first cutting edge. This arrangement of grooves and ridges would define corrugations on the trailing face which can serve to direct rocks, wood chips and other debris away from the first cutting edge thereby minimizing dispersion of the debris over the cutting area. In addition, the ridges can themselves define additional cutting edges for improved cutting performance. In such other embodiments, the grooves could be machine ground into the trailing face during fabrication. Alternatively, the first cutting portion could be cast or forged so as to form the arrangement of alternating grooves and ridges.

In still other embodiments, the corrugations could be configured differently. For instance, the corrugations could have a generally arcuate or zigzag profile when viewed in cross-section. Other profiles may also be employed to similar advantage.

In this embodiment, the length L₂ of the first cutting portion 94 (as measured from the first cutting edge 152 to the juncture where the lower portion 162 of the trailing face 142 meets the first end 100 of the base portion 98) is 0.89 in. The ratio L₂:L₁ (i.e. the ratio between the length L₂ of the first cutting portion 94 and the length L₁ of the base portion 98) is approximately 0.34. In other embodiments, the first cutting portion may be configured to be shorter or longer to suit a particular application or to achieve a particular angle of attack. In such embodiments, preferably, the ratio L₂:L₁ lies between approximately 0.17 and approximately 0.44.

The second cutting portion 96 is carried on the second end 102 of the base portion 98 in a generally, forwardly leaning or canted fashion. As mentioned earlier, in this preferred embodiment the second cutting portion 96 is configured to be the mirror image of the first cutting portion 94. In like fashion to the first cutting portion 94, the second cutting portion 96 includes a leading face 170, an opposed trailing face 172 and two spaced-apart lateral faces 174 and 176. The leading face 170 of the second cutting portion 96 joins the leading face 104 of the base portion 98 while the trailing face 172 joins the trailing face 106. As best shown in FIG. 15, an external obtuse angle θ₂ is formed between the leading face 170 and the leading face 104. In this embodiment, the angle θ₂ measures approximately 139 degrees. In other embodiments, a different angle may be employed.

Each lateral face 174, 176 is coplanar with the corresponding lateral face 108, 110 of the base portion 98 such that the one merges smoothly with the other; the orientation of the lateral faces 174 and 176 contributing to the overall hourglass shape of the cutting tooth 90.

The leading and trailing faces 170 and 172 cooperate with each other to define a tapering, wedge-like, profile 180 that terminates in a second cutting edge 182. The second cutting edge 182 is carried forwardly of the leading face 104 of the base portion 98 such that when the second cutting portion 96 is in its operative orientation it tends to be the first element of the cutting tooth 90 to make contact with the brush to be cut. The second cutting edge 182 is carried at an angle α₂ (as measured between the leading face 170 and a notional plane extending parallel to the midplane M). The angle α₂ corresponds to the “angle of attack” of the second cutting portion 96, that is, the angle at which the first cutting edge 182 approaches the material to be cut. Preferably, this angle α₂ measures between about 20 degrees and about 75 degrees. In the embodiment shown in FIG. 15A, the angle α₂ measures 49 degrees. It will be appreciated that a smaller angle of attack may be desirable in instances where the brush to be cut includes harder woods. Conversely, a larger angle of attack may be used where the second cutting edge 182 is intended to act on softer woods.

The second cutting edge 182 extends generally linearly between the lateral faces 174 and 176 and substantially parallel to the rotational axis R-R of the brush cutting head 24. However, in alternative embodiments, the second cutting edge could be configured differently. For instance, the second cutting edge could be configured to extend generally diagonally between the lateral faces 174 and 176, askew of the rotational axis R-R. This configuration would tend to favor one end of the cutting edge over the other contacting the brush. In a further alternative, the second cutting edge could be scalloped or formed to extend in a generally, zigzagging fashion.

In this embodiment, the width W₃ of the second cutting edge 182 measures 3.0 in. In other embodiments, the width of the second cutting edge could be greater or lesser.

When the cutting tooth 90 is mounted within the station 52 and the second cutting portion 96 is in its operative orientation, the second cutting edge 182 extends beyond the outer sidewall edges 62 of adjacent collars 50 to facilitate the cutting action of the tooth. In operation, the second cutting edge 182 of each cutting tooth 90 comes into contact with the brush thereby creating debris as a result of the cutting action of the cutting tooth 90. As was the case with the first cutting edge 152, as the debris passes over the second cutting edge 182, it abrades the surface of the second cutting edge 182 thereby sharpening the cutting tooth 90. This sharpening action tends to maintain or enhance the cutting efficiency of the cutting tooth and tends to reduce the need for mechanical sharpening. Thereafter the debris may travel along the leading and/or trailing face 170 and 172 to be carried away from second cutting edge 182. As shown in FIG. 4B, the second cutting portion 96 is spaced away from the finger-like projection 74 of the collar 50 so as to provide a clearance for the passage of debris. Beyond the finger-like projection 74, a larger clearance for evacuating debris exists between the edge 72 of the collar 50 on the one side, and the base portion 98 and second cutting portion 96 on the other.

Returning to FIG. 15A, the trailing face 172 of the second cutting portion 96 has an upper portion 190 and a lower portion 192. The upper portion 190 extends between the second cutting edge 182 and the lower portion 192. The upper portion 190 is bent relative to the lower portion 192 such that an internal obtuse angle φ₂ is defined therebetween. In the present embodiment, the angle φ₂ measures approximately 161 degrees. In other embodiments, a different angle may be employed.

In the embodiment shown in FIG. 12, the upper and lower portions 190 and 192 of the trailing face 172 are shown to be planar. This need not be the case in every application. As explained above in the context of upper and lower portions 160 and 162, the former portions can be formed with an arrangement of alternating grooves and ridges extending generally transverse of the second cutting edge. This arrangement of grooves and ridges would define corrugations on the trailing face which can serve to direct rocks, wood chips and other debris away from the first cutting edge thereby minimizing dispersion of the debris over the cutting area. In addition, the ridges can themselves define additional cutting edges for improved cutting performance. In such other embodiments, the grooves could be machine ground into the trailing face during fabrication. Alternatively, the second cutting portion could be cast or forged so as to form the arrangement of alternating grooves and ridges.

In still other embodiments, the corrugations could be configured differently. For instance, the corrugations could have a generally arcuate or zigzag profile when viewed in cross-section. Other profiles may also be employed to similar advantage.

In this embodiment, the length L₃ of the second cutting portion 96 (as measured from the second cutting edge 182 to the juncture where the lower portion 192 of the trailing face 172 meets the second end 102 of the base portion 98) is 0.89 in. The ratio L₃:L₁ (i.e. the ratio between the length L₃ of the second cutting portion 96 and the length L₁ of the base portion 98) is approximately 0.34. In other embodiments, the second cutting portion may be configured to be shorter or longer to suit a particular application or to achieve a particular angle of attack. In such embodiments, preferably, the ratio L₃:L₁ lies between approximately 0.17 and approximately 0.44.

Preferably, the cutting tooth 90 is fabricated from hardened steel selected for its strength and improved resistance to wear and impact. However, in other embodiments, the cutting tooth could be fabricated from other suitable materials exhibiting similar material characteristics.

Advantageously, the provision of two (or dual) cutting edges 152 and 182 on the cutting tooth 90 tends to lengthen the service life of the cutting tooth 90 and minimize maintenance and/or repair. When the first cutting edge 152 wears down, is rendered inoperative, or its cutting efficiency is otherwise impaired, the orientation of the cutting tooth 90 may be inverted so as to position the second cutting edge 182 in its operative orientation and have the first cutting edge in its inoperative orientation. Brush cutting activities can resume with the second cutting edge 182 of the cutting tooth 90 acting on the brush to be cut.

In this embodiment, with both first and second cutting edges 152 and 182 oriented at an angle of attack of 49 degrees, the notional diameter D₁ of a circle C₁ drawn within the envelope of the cutting tooth 90 (as shown in FIG. 15B) measures 4.4 in. In other embodiments, the diameter D may be different to suit a particular application. However, in order to ensure optimal cutting effectiveness of the cutting tooth 90 it has been found that preferably, the diameter D measures between 3.5 in. and 4.9 in., with the low end of the range for diameter D corresponding to an angle of attack for both first and second cutting edges of 20 degrees and the high end of the range for diameter D corresponding to an angle of attack for both first and second cutting edges of 75 degrees. In FIG. 15B, the cutting edges arranged at angles of attack of 20 degrees and 75 degrees are shown in dashed lines. The lower limit of the diameter D is identified in FIG. 15B with reference symbol Dₘᵢₙ and the corresponding notional circle with reference symbol Cₘᵢₙ. Along the same lines, the higher limit of the diameter D is identified in FIG. 15B with reference symbol Dₘₐₓ and the corresponding notional circle with reference symbol Cₘₐₓ.

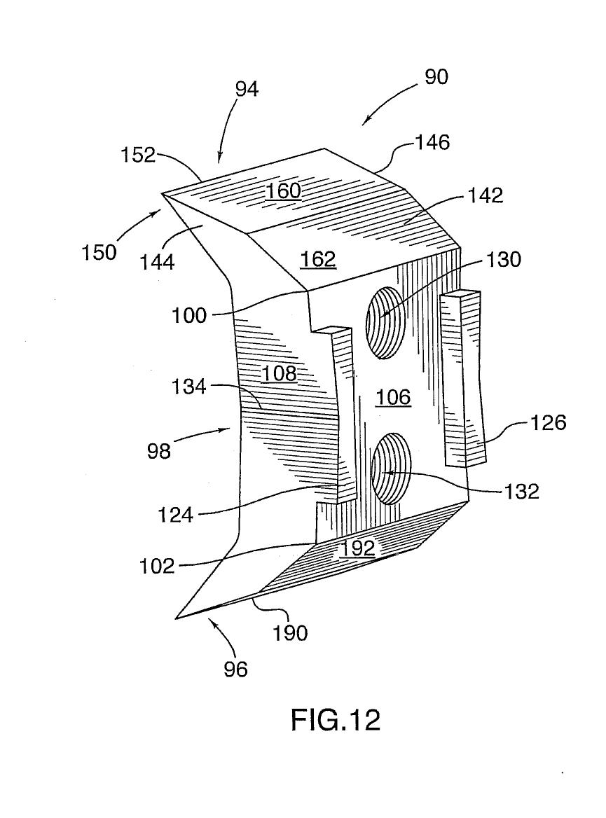

In the embodiment shown in FIGS. 11 to 15A and 15B, the first cutting portion 94 is a mirror image of the second cutting portion 96 such that it is identically sized and the first cutting edge 152 has the same angle of attack as the second cutting edge 182. This need not be the case in every application. In certain embodiments, it may be desirable to have one cutting portion sized differently than the other, or to have one cutting edge with a different angle of attack than the other cutting edge. The orientation of the cutting edges of each cutting tooth on the brush cutter head could be modified to suit particular field conditions. For example, where soft woods are to be cut, the cutting edge with the larger angle of attack may be used. Conversely, where hard woods are to be cut, the cutting edge with the smaller angle of attack will be used. Because each cutting tooth carries two opposed cutting edges, there is no need to have two sets of cutting teeth with differently angled cutting edges, thereby enhancing the versatility of the brush cutting head. Moreover, changing the orientation of the cutting tooth so that one cutting edge becomes operative can be accomplished quickly and efficiently resulting in less downtime during maintenance and enhanced convenience.

Referring to FIGS. 4A, 4B, 8 to 10, the mounting assembly 92 includes a mounting block 200 which is configured for securely holding the cutting tooth 90, a threaded fastener in the nature of a bolt 202 and a washer 203. The mounting block 200 has a body 204 that is formed with a sloping upper face 206, a curved lower face 208, a leading face 210, a trailing face 212, and a pair of opposed lateral faces 214 and 216. The lower face 208 has a leading end 218, a trailing end 220 and outer lateral margins 222 and 224 extending between the leading and trailing ends 218 and 220. The curvature of the lower face 208 corresponds substantially to the curvature of the curved outer surface 48 of the support body 40. In the regions where the lower face 208 meets the lateral faces 214 and 216, the outer lateral margins 222 and 224 are trimmed back at an angle (or truncated) to facilitate welding of the mounting block 200 to the support body 40.

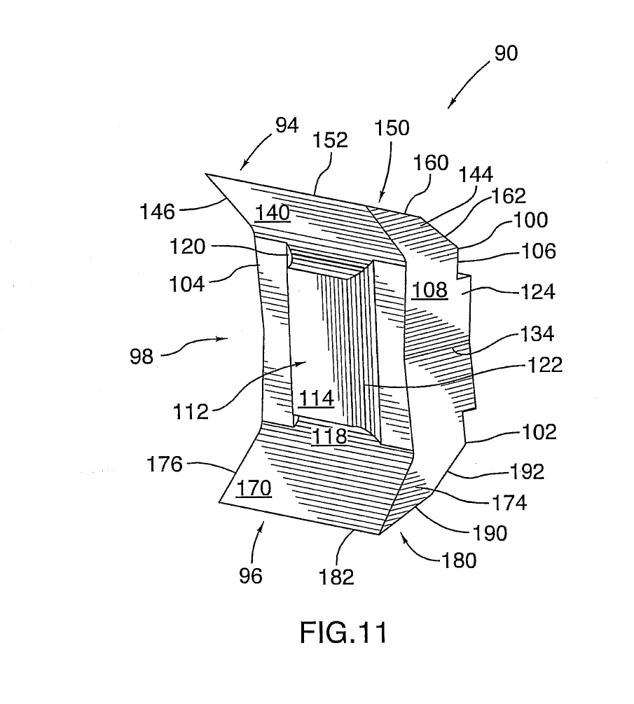

Referring specifically to FIG. 10, the trailing face 212 extends straight from the trailing end 220 of the lower face 208 to the upper face 206. At the juncture of the trailing face 212 and the upper face 206, the body 204 is formed with a cutout 228 shaped like an inverted thumbprint. Defined in the end face 230 of the cutout 228 and extending through the body 204 to open onto the leading face 210 is a smooth bore 232. The bore 232 is configured to receive the bolt 202.

The upper face 206 runs at incline towards the leading face 210. The leading face 210 is recessed from the leading end 218 of the lower face 208 thereby defining a horizontal shelf 238 proximate the lower face 208. The leading face 210 extends upwardly from the horizontal shelf 238 to meet the upper face 206. In the regions where the leading face 210 meets the lateral faces 214 and 216, narrow longitudinal rebates 240 and 242 are formed which extend from the upper face 206 about two-thirds of the way toward the horizontal shelf 238. The provision of rebates 240 and 242 facilitates the proper positioning of the cutting tooth 90 on the mounting block 200 by serving as guide means for the location of the abutment shoulders 124 and 126. During assembly of the cutting tooth 90 with the mounting block 200, the abutment shoulders 124 and 126 are seated within the rebates 240 and 242.

The width of the mounting block body 204 as measured between the lateral faces 214 and 216 is slightly less than the narrowest width of the cutting tooth 90 taken at the midplane M such that the lateral extremities of the cutting tooth 90 can be seen to extend beyond the lateral extremities of the mounting block body 204.

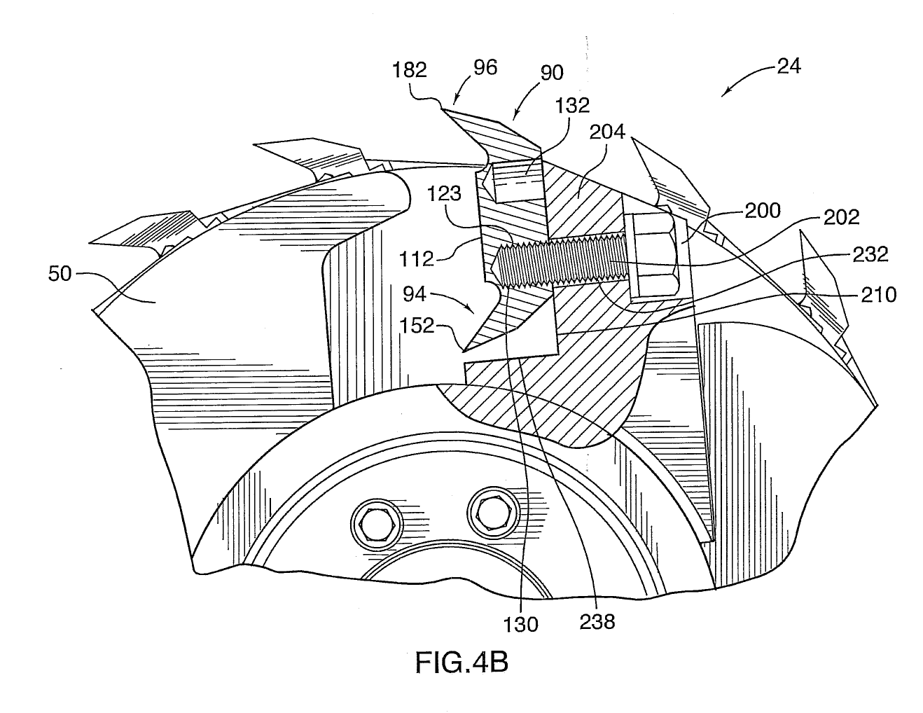

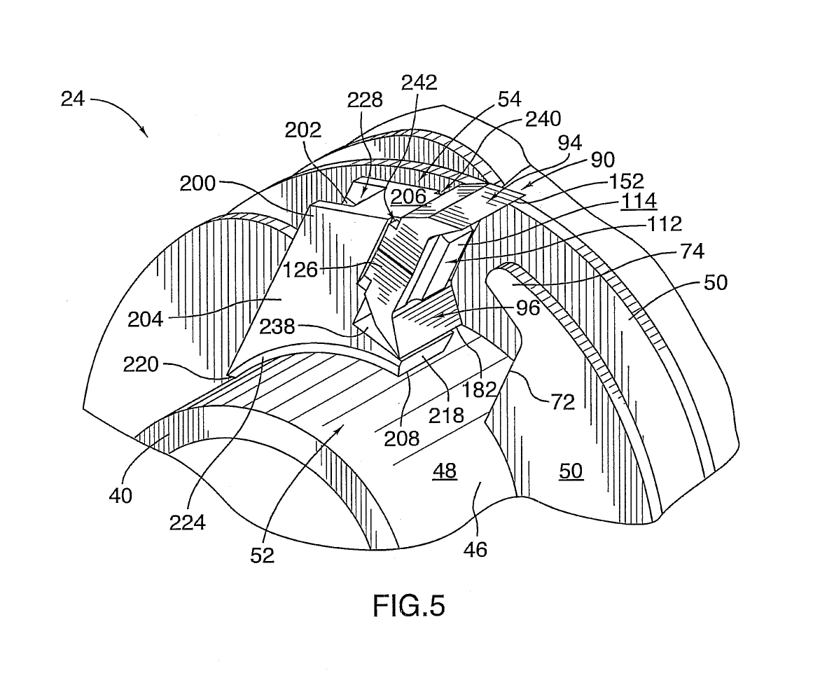

Referring to FIGS. 5 and 6, during fabrication of the brush cutting head 24, the lower face 208 of the mounting block 200 is positioned onto the curved outer surface 48 of the support body 40 with the trailing face 210 of the mounting block 200 abutting and welded to the straight edge 76 of the collar sidewall 60. The trailing end 220 of the mounting block lower face 208 sits on the relatively small shoulder 78 defined on the collar 50. The collar 50 is disposed centrally relative to the trailing face 210 and serves the function of a reinforcing spine for the cutting tooth assembly 54. When the cutting tooth 90 strikes a hard object, the force of impact is distributed through the cutting tooth 90, the mounting assembly 92, the reinforcing collar 50 and the support body 40.

In this embodiment, the mounting block 200 is fabricated from hardened steel selected for its strength and improved resistance to wear and impact. In other embodiments, the mounting block could be fabricated from other suitable materials exhibiting similar material characteristics.

Referring now to FIGS. 4A, 4B and 6, the attachment of the cutting tooth 90 to the brush cutting head 24 is now described in greater detail. The trailing face 106 of the base portion 98 is brought to bear against the leading face 210 of the mounting block body 204 with care being taken to ensure that each abutment shoulder 124, 126 of the base portion 98 aligns with its corresponding rebate 240, 242 formed in the mounting block body 204 and that the blind bore 130 or 132 (as the case may be) defined in the trailing face 106 of the base portion 98 is aligned with the bore 232 formed through the mounting block body 204. Where the first cutting portion 94 is to be put into its operative position, the blind bore 132 will be aligned with the bore 232 and the first cutting edge 152 will be located furthest from the outer curved surface 48 of the support body. In contrast, the second cutting edge 182 will be arranged closest to the outer curved surface 48 and where it will occupy its non-operative position (see FIG. 4A).

Alternatively, where the second cutting portion 96 is to be put into its operative position, the blind bore 130 will be aligned with the bore 232 and the second cutting edge 182 will be located furthest from the outer curved surface 48. The first cutting edge 152 will be arranged closest to the outer curved surface 48 where it will occupy its non-operative position (see FIG. 4B). Once the bore 130 or 132 is aligned with bore 232, the bolt 202 with washer 203 may be inserted therethrough and tightened until the cutting tooth 90 is firmly secured onto the mounting block 200.

In either case where the first cutting edge 152 or the second cutting edge 182 is its non-operative position, it can be seen that there is sufficient clearance between that cutting edge and the horizontal shelf 238 of the mounting block 200 to avoid any physical contact or interference between them.

Because the end of the bolt 202 remains captive within the mounting block body and does not extend beyond the leading face, the risk that the bolt will experience a sheer failure as a result of a hard piece of wood or rock violently striking the bolt is mitigated. This is an improvement over the prior art cutting tooth and mounting block combination described in United States Patent Publication No. 2010/0044487, in which a portion of the bolt and the nut fastened thereon projected from the leading face of the cutting tooth and were thus exposed to such violent impacts.

As best shown in FIG. 6, when the cutting tooth 90 is fastened to the mounting block 200 the abutment shoulder 124 and 126 can be seen to wrap around the leading face 210 of the mounting block body 204 and will tend to prevent the cutting tooth 90 from rotating relative to the mounting block 200 and from bringing the cutting edge 152 or 182 (as the case may be) out of its proper orientation. In this way, the need to provide locating means (in the nature of a projecting guide member) on the bottom of the cutting tooth and on the horizontal shelf of the mounting block to ensure the proper orientation of the cutting tooth, may be obviated along with the problems associated therewith.

It will thus be appreciated that the cutting tooth fabricated in accordance with the principles of the present invention is optimally configured and sized for attachment to the mounting blocks of known brush cutting heads without physical interference with same, and for enhanced cutting efficiency and extended service life of the cutting tooth.

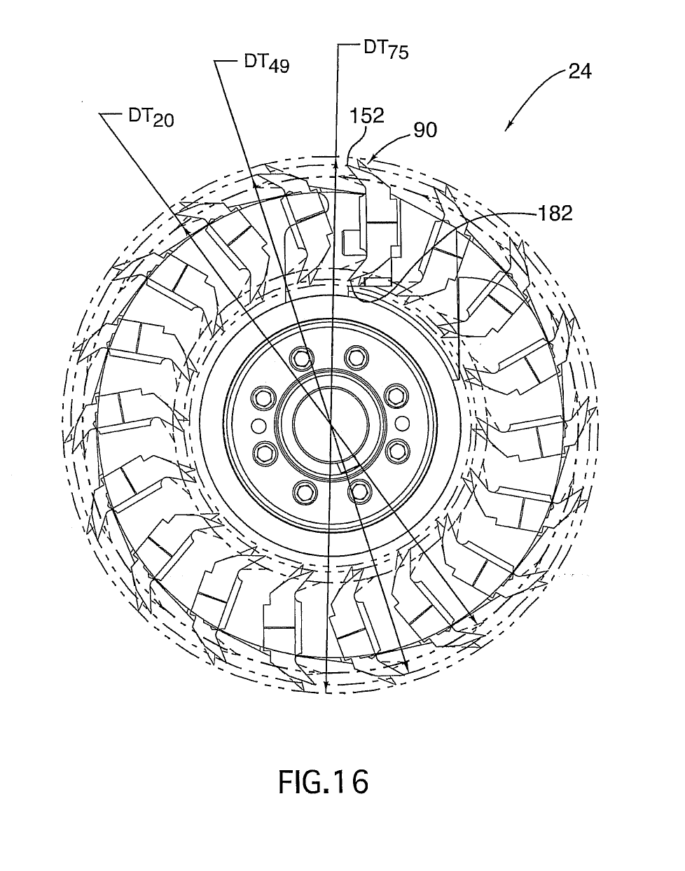

FIG. 16 shows an end view of the brush cutting head 24 with all the cutting teeth 90 visible with their first cutting edges 152 in their respective operative positions. In this figure, the first cutting edges 152 of the cutting teeth 90 can be seen to have an angle of attack α₁ of 49 degrees shown in solid lines and minimum and maximum angles of attack 20 and 75 degrees, respectively, shown in dashed lines. In this embodiment, the diameter DT of the brush cutting head 24 (as measured between the first cutting edges 152 of opposed cutting teeth 90 at an angle of attack of 49 degrees) measures 19.82 in. In this embodiment, the ratio of the diameter D₁ (i.e. the diameter of a circle C₁ drawn within the envelope of the cutting tooth 90) to the diameter DT₄₉ is 0.22.

Where the first cutting edges 152 are oriented at an angle of attack of 20 degrees, the diameter DT₂₀ measures 18.94 in. and the ratio of the diameter Dₘᵢₙ to DT₂₀ is 0.18. Where the first cutting edges 152 are oriented at an angle of attack of 75 degrees, the diameter DT₇₅ measures 20.44 in. and the ratio of the diameter Dₘₐₓ to DT₇₅ is 0.24. It has been found that for optimal sizing and cutting efficiency the ratio of D to DT should lie between approximately 0.18 and 0.24.

Although the foregoing description and accompanying drawings relate to specific preferred embodiments of the present invention as presently contemplated by the inventor, it will be understood that various changes, modifications and adaptations, may be made without departing from the spirit of the invention.

What is claimed is:

1. A cutting tooth for attachment to a mounting block carried on a brush cutting head, the cutting tooth comprising:
a longitudinal body provided with a leading face; a trailing face; and a pair of opposed, first and second cutting portions carried at either end of the longitudinal body;
the leading face having a projection disposed thereon to reinforce the longitudinal body; the projection having a leading projection face;
the trailing face having defined therein at a location intermediate the ends of the longitudinal body at least one threaded, blind bore; the at least one blind bore extending substantially into the projection but stopping short of the leading projection face; the at least one blind bore being configured to receive therein a threaded bolt for securing the cutting tooth to the mounting block;
the first cutting portion having a tapering profile that terminates in a first cutting edge; the first cutting edge having a first angle of attack relative to a first plane parallel to the midplane M; the first angle of attack lying between 20 degrees and 75 degrees; and
the second cutting portion having a tapering profile that terminates in a second cutting edge; the second cutting edge having a second angle of attack relative to a second plane parallel to the midplane M; the second angle of attack lying between 20 degrees and 75 degrees;
when the cutting tooth is secured to the mounting block one of the first and second cutting portions is in an operative position and the other of the first and second cutting portions is in an inoperative position.

2. The cutting tooth of claim 1 wherein the longitudinal body further includes a midplane M oriented transverse of the longitudinal body; the longitudinal body being symmetrical about the midplane M such that the first cutting portion is a mirror image of the second cutting portion.

3. The cutting tooth of claim 2 wherein the longitudinal body further includes a plane P perpendicular to the midplane M; the longitudinal body being symmetrical about the plane P.

4. The cutting tooth of claim 1 wherein the longitudinal body has an hourglass shape.

5. The cutting tooth of claim 1 wherein the longitudinal body further comprises a base portion having a leading face and an opposed trailing face; the base portion being disposed between the first and second cutting portions.

6. The cutting tooth of claim 5 wherein the base portion is sized longer than at least one of the cutting portions.

7. The cutting tooth of claim 6 wherein the base portion is sized longer than both the cutting portions.

8. The cutting tooth of claim 6 wherein:
the base portion has a length L₁;
the first cutting portion has a length L₂; and
the ratio L₂:L₁ lies between approximately 0.17 and approximately 0.44.

9. The cutting tooth of claim 6 wherein:
the base portion has a length L₁;
the second cutting portion has a length L₃; and
the ratio L₃:L₁ lies between approximately 0.17 and approximately 0.44.

10. The cutting tooth of claim 5 wherein the base portion has a pair of opposed lateral faces; and the width of the base portion as measured between the lateral faces tapers toward the midplane.

11. The cutting tooth of claim 5 wherein the projection occupies a substantial portion of the base portion leading face.

12. The cutting tooth of claim 5 wherein the projection has a substantially rectangular shape defined by smoothly-radiused sides.

13. The cutting tooth of claim 5 wherein the leading projection face is planar.

14. The cutting tooth of claim 13 wherein the leading projection face is generally parallel to the base portion trailing face.

15. The cutting tooth of claim 5 wherein the at least one blind bore includes a first blind bore located adjacent the juncture of the base portion and the first cutting portion, and a second blind bore located adjacent the juncture of the base portion and the second cutting portion.

16. The cutting tooth of claim 5 further comprising means for preventing rotation of the cutting tooth relative to the mounting block.

17. The cutting tooth of claim 16 wherein the rotation preventing means includes a pair of spaced apart, raised abutment members projecting from the trailing face of the base portion and extending longitudinally therealong; the spacing between the abutment members being sized large enough to accommodate a portion of the mounting block therein.

18. The cutting tooth of claim 1 wherein the first angle of attack is equal to the second angle of attack.

19. The cutting tooth of claim 18 wherein the first and second angles of attack measure 49 degrees.

20. The cutting tooth of claim 1 wherein the first angle of attack is greater than the second angle of attack.

21. The cutting tooth of claim 1 wherein the first and second cutting edges define a cutting tooth envelope capable of accommodating a circle having a diameter ranging between 3.5 and 4.9 in.

22. The cutting tooth of claim 21 wherein, when the first and second angles of attack measure 20 degrees, the cutting tooth envelope is capable of accommodating a circle having a diameter measuring 3.5 in.

23. The cutting tooth of claim 21 wherein, when the first and second angles of attack measure 49 degrees, the cutting tooth envelope is capable of accommodating a circle having a diameter measuring 4.4 in.

24. The cutting tooth of claim 21 wherein, when the first and second angles of attack measure 75 degrees, the cutting tooth envelope is capable of accommodating a circle having a diameter measuring 4.9 in.

25. A cutting tooth assembly for a brush cutting head comprising:
a mounting block carried on the brush cutting head, the mounting block having a leading face, a trailing face and a bore extending between the leading and trailing faces of the mounting block;
a cutting tooth releasably attachable to the mounting block, the cutting tooth having:
a longitudinal body provided with a leading face; a trailing face; and a pair of opposed, first and second cutting portions carried at either end of the longitudinal body;
the leading face having a projection disposed thereon to reinforce the longitudinal body; the projection having a leading projection face;
the trailing face having defined therein at a location intermediate the ends of the longitudinal body at least one threaded, blind bore; the at least one blind bore extending substantially into the projection but stopping short of the leading projection face; the at least one blind bore being configured to receive therein a threaded bolt for securing the cutting tooth to the mounting block;
the first cutting portion having a tapering profile that terminates in a first cutting edge; the first cutting edge having a first angle of attack relative to a first plane parallel to the midplane M; the first angle of attack lying between 20 degrees and 75 degrees; and
the second cutting portion having a tapering profile that terminates in a second cutting edge; the second cutting edge having a second angle of attack relative to a second plane parallel to the midplane M; the second angle of attack lying between 20 degrees and 75 degrees; and
a bolt for fastening the cutting tooth to the mounting block; the bolt being insertable into the at least one blind bore of the longitudinal body and the bore defined in the mounting block;
when the cutting tooth is secured to the mounting block one of the first and second cutting portions is in an operative position and the other of the first and second cutting portions is in an inoperative position.

26. The cutting tooth of claim 25 wherein the at least one blind bore includes a first blind bore located nearer to the first cutting portion than to the second cutting portion, and a second blind bore located nearer to the second cutting portion than to the first cutting portion.

27. The cutting tooth of claim 26 wherein, when the cutting tooth is secured to the mounting block with the first cutting portion in the operative position, the bolt extends through the second blind bore.

28. The cutting tooth of claim 26 wherein, when the cutting tooth is secured to the mounting block with the second cutting portion in the operative position, the bolt extends through the first blind bore.

29. A brush cutting head comprising:
a plurality of mounting blocks carried on the brush cutting head; each mounting block of the plurality having a leading face, a trailing face and a bore extending between the leading and trailing faces of the mounting block;
a plurality of cutting teeth releasably attachable to the plurality of mounting blocks, each cutting tooth having:
a longitudinal body provided with a leading face; a trailing face; and a pair of opposed, first and second cutting portions carried at either end of the longitudinal body;
the leading face having a projection disposed thereon to reinforce the longitudinal body; the projection having a leading projection face;
the trailing face having defined therein at a location intermediate the ends of the longitudinal body at least one threaded, blind bore; the at least one blind bore extending substantially into the projection but stopping short of the leading projection face; the at least one blind bore being configured to receive therein a threaded bolt for securing the cutting tooth to its associated mounting block;
the first cutting portion having a tapering profile that terminates in a first cutting edge; the first cutting edge having a first angle of attack relative to a first plane parallel to the midplane M; the first angle of attack lying between 20 degrees and 75 degrees; and
the second cutting portion having a tapering profile that terminates in a second cutting edge; the second cutting edge having a second angle of attack relative to a second plane parallel to the midplane M; the second angle of attack lying between 20 degrees and 75 degrees; and
a plurality of bolts for fastening the plurality of cutting teeth to the plurality of mounting blocks, each bolt of the plurality being insertable into the at least one blind bore of one of the cutting teeth of the plurality and the bore defined in the corresponding one of the mounting blocks of the plurality;

30. A cutting tooth for attachment to a mounting block carried on a brush cutting head, the cutting tooth comprising:
a longitudinal body provided with a leading face; a trailing face; a midplane M oriented transverse of the longitudinal body; a pair of opposed, first and second cutting portions carried at either end of the longitudinal body and extending away from each other and away from the leading face in a forwardly leaning fashion; and at least one threaded blind bore defined in the trailing face at a location intermediate the first and second cutting portions; the at least one threaded blind bore being configured to receive therein a threaded bolt for securing the cutting tooth to the mounting block;
the first cutting portion having a tapering profile that terminates in a first cutting edge; the first cutting edge having a first angle of attack relative to a first plane parallel to the midplane M; the first angle of attack lying between 20 degrees and 75 degrees;
the second cutting portion having a tapering profile that terminates in a second cutting edge; the second cutting edge having a second angle of attack relative to a second plane parallel to the midplane M; the second angle of attack lying between 20 degrees and 75 degrees;
the first and second cutting edges defining a cutting tooth envelope capable of accommodating a circle having a diameter ranging between 3.5 and 4.9 in.; and
when the cutting tooth is secured to the mounting block one of the first and second cutting portions is in an operative position and the other of the first and second cutting portions is in an inoperative position.

31. The cutting tooth of claim 30 wherein, when the first and second angles of attack measure 20 degrees, the cutting tooth envelope is capable of accommodating a circle having a diameter measuring 3.5 in.

32. The cutting tooth of claim 30 wherein, when the first and second angles of attack measure 49 degrees, the cutting tooth envelope is capable of accommodating a circle having a diameter measuring 4.4 in.

33. The cutting tooth of claim 30 wherein, when the first and second angles of attack measure 75 degrees, the cutting tooth envelope is capable of accommodating a circle having a diameter measuring 4.9 in.
